(19) United States
(12) Patent Application Publication
(10) Pub. No.: US 2003/0127242 A1
(43) Pub. Date: Jul. 10, 2003

(54) Sleeved insulating body with screw connector for production of a cable connection for medium-voltage plastic cables

(76) Inventors: Juergen Pilling, Spitzkunnersdorf (DE); Jens Lambrecht, Niedernhausen (DE)

Correspondence Address: Law Offices of Karl Hormann, PO Box 381516, Cambridge, MA, 02238-1516, US

(21) Appl. No.: 10/296,785

(22) PCT Filed: May 21, 2001
(86) PCT No.: PCT/DE01/01925

(51) Int. Cl. H01B 17/00

(52) U.S. Cl. 174/138 R

(57) ABSTRACT

The basic construction of the sleeved insulating body (8), with integrated screw connector, comprises enclosing a metallic screw connector (5) in an adhering insulation jacket (8.1), by means of, for example, an injection molding process, said jacket, extending at both front faces into elastic collars (8.2) which take cable ends. Openings (6) are provided in the insulating jacket at the access points for clamping screws (5.2) for the electrical and mechanical connection of the cable with the connector which, after removal of the tear-off caps on the clamp screws, are sealed by means of stoppers (10) made from insulating material or by means of a tubular elastic gaiter (17), each with a field controller. The field controller (9) over the cable end may be integrated in the collar (8.2). The insulating capability of the sleeve is produced when the cable ends are introduced through the collars (8.2) and the cable ends are screwed in the screw connector (5) and the screw openings are sealed with the field controlled stoppers (10) or with an elastic gaiter (17).

### BACKGROUND OF THE INVENTION

1. Field of the Invention

For connecting energy cables for nominal voltages in excess of 1 kV to 42 kV (medium voltage) it is customary, similar to low voltage applications, to use metallic sleeve connectors. The non-insulated ends of the conductors to be connected are inserted into the connector at its two ends. The mechanically rigid and electrically conductive connection is provided by pressure deformation by means of a special pressure tool (press connector) or by screwing by means of screws disposed laterally of the connector (screw connector). The torque required for a reliable connection is ensured either by means of a torque wrench or by rupture of the screw head when the requisite value has been reached.

2. The State of the Prior Art

Screw connectors with shear-off screws are gaining increasing acceptance by users, since, unlike press connectors, they require no special tools. Moreover, a given screw connector may be used in connection with conductors of different cross-sections. It is also possible, within a certain range of cross-sections, to connect cables of different cross-sections as is often required when enlarging existing arrangements.

To reconstruct the electrical insulation and the mechanical exterior protection, the metallic connectors and adjacent conductor sections have to be covered by suitable insulating materials in the area from which the insulation was removed. This can be done in several ways all of which are based on the assumption that initially the electrical connection and mechanical anchoring of the two conductor ends is established with one of the metallic connectors mentioned above.

Means known as field controllers or field equalizers for reducing the electrical field strength are required over the connector and over the abutment edge of the exterior conductive layer of the cable. For this purpose, an electrically conductive layer (interior conductive layer) is provided in the area over the connector which acts as a Faraday cage in respect of the connector and any voids surrounding it. In some cases, the connector is covered by a mastic material of higher permittivity (dielectric constant) than the insulating layer of the sleeve positioned over it. In the area of the abutment edge of the outer conductive layer there is arranged either a funnel-shaped electrode, made, for instance, of a conductive plastic (field controlling funnel, capacitive field regulation) or a layer of insulating material of higher permittivity (refractive field regulation). Further components of the structure of the sleeve insulation are an insulating layer and an outer conductive layer for limiting the electric field.

The following description is limited to four essential and more or less proven principles of constructing the sleeve insulation.

First, wrapped sleeve: The above mentioned elements of the sleeve insulating body are fabricated by the wrapping of insulating and semiconductive tapes. The field regulation above the abutment edge of the outer conductive layer is capacitive; the wrapping made in this area is of bat configuration.

The advantage of this technology is that no parking position is needed for keeping elements of the sleeve prior to the connection.

The disadvantage is the long time required for the assembly with air inclusions which may lead to partial discharges being possible. Another disadvantage is that no terminal factory test of the sleeve insulating body can be performed.

Second, heat shrink sleeve: In this case the sleeve insulating body is constructed of heat-shrinking polyolifine hoses which prior to the assembly of the connector have to be placed in a parking position at one end of the cable. For equalizing the field above the connector the mastic mention above is used. Regulation of the field above the abutment edge of the outer conductive layer is refractive. Customarily the outer conductive layer is connected to the insulating layer disposed below it by coextrusion.

The short time required for its assembly is a particular advantage.

The disadvantage here, too, is the requisite parking position above the shield of the cable. Furthermore, a gas flame which may cause thermal damage of the material is required for the assembly. Also, it is not possible to perform a final factory check.

Third, push-on sleeve: In a push-on sleeve the sleeve insulating body is made by its manufacturer primarily by injection molding of elastic materials (e.g. silicon, ethylene-propylene-diene-monomer (EDPM)). Prior to the assembly of the connector it is put into a parking position over the outer conductive layer on one of the two cable ends. The internal diameter of the usually tubular sleeve insulating body is smaller than the diameter over the core insulation of the cable of the smallest conductor cross-section in the area of application. In this manner, a lasting engagement pressure is attained at the interface between core insulation and sleeve insulation. Following the assembly of the connector, the sleeve insulation body is moved back to its final position. For moving, a lubricant, such a silicon oil, is usually used. The field regulation may be capacitive or refractive.

The advantages of this technology are the simple assembly without gas flame. A check of the transverse insulation of the sleeve insulating body at the manufacturer's is also possible.

The essential disadvantage is, again, the requisite parking position above the outer conductive layer, it being necessary in this case at this area to remove the cable shield. This involves more complex labor and an outer protective sleeve of the length of the parking position. The force required for the movement is large and imposes an upward limit in respect of the size of the field of application.

Fourth, cold shrinkage sleeve in accordance with German patent DE 39 43 296 C2: The structure of the sleeve insulating body resembles the structure of the push-on sleeve. However, prior to assembly it is sufficiently expanded radially by a special device so it may be moved to a parking position over the cable shield. Following assembly of the connector, the expansion device is removed, the insulating body relaxes and “shrinks cold” to its final state. The device may, for instance, be a support coil which is inserted by the manufacturer. In that case the insulating body is transported and stored in a strongly expanded state (e.g. 230%) which may lead to material fatigue of the elastomeric material and to a permanent expansion. Other manufacturers (Cossonay of Switzerland and ABB Kabeldon of Sweden) use tubular longitudinally separable support sleeves which are inserted prior to assembly which results in a shorter super-expansion time. In a third variation the elastic sleeve insulating body is slipped onto the cable shield by a push-on aide consisting of PE slip rods thus avoiding a parking position on the outer conductive layer and minimizing time and degree of super-expansion during assembly.

A push-on aid of this kind consisting of an annular arrangement of spaced PE slip rods is known from German laid-open patent specification DE 195 10 598 A1. Furthermore, a sleeve insulating body for connecting two cables in the medium voltage range is known from German laid-open patent specification which is provided with a pressure or screw connector for the conductors to be connected and with means for controlling the electrical field, such as field controlling hoses or conically coiled tapes.

German laid-open patent specification DE 197 27 567 A1 describes a branch terminal for a branch cable and house connecting sleeve in which metallic screw connector consisting of a terminal piece and terminal screws is rigidly enclosed by an insulation body. The insulating body consists of an insulating jacket which covers the screw connector and which at the two front faces of the connector is provided with elastic gaskets for receiving the cable ends, and which at the accesses to the terminal screws is provided with openings which may be closed by plugs of insulating material.

Shrinkable conical hollow bodies for adjusting the cross-section of insulation passages or grommets to be put against the cross-section of the cable and which also contain field controlling bodies are known from German laid-open patent specification DE 198 20 869 A1.

### OBJECT OF THE INVENTION

Based upon the described state of the art, it is an object of the invention to provide an sleeve insulating body which requires no parking position, which may be assembled in a simple manner, which requires little insulating material and which may be manufactured cost-efficiently. It must be possible, for increasing its reliability during operation, to subject the sleeve insulating body to a 100% test under high voltage.

These and other objects are accomplished by the embodiments described in greater detail hereinafter.

### SUMMARY OF THE INVENTION

In accordance with the invention, a metallic screw connector and an associated water-impervious sleeve insulating body covering the screw connector are put together as a compact assembly component by the manufacturer such that the screw connector is rigidly integrated in the sleeve insulating body the and sections of which are elastic. Preferably, this assembly component is fabricated by its manufacturer as an individually tested screw connector—sleeve insulating body unit and is furnished to customers in this compact form.

The basic structure of the sleeve insulating body with integrated screw connector consists, for instance, of a metallic screw connector being enclosed, for instance by injection molding, by a rigidly adhering insulating jacket which, at the two front ends of the connector, extends as elastic grommets for receiving cable ends.

At the accesses to the terminal screws for the electrical and mechanical connection of the cables with the connector, openings are formed in the insulating jacket which following the removal of the shear-off heads from the terminal screws are closed by plugs of insulating material or by an elastic cuff.

If closed by plugs, the openings show a formed cylindrical or curved margin which is concentrically covered by the head of the plug. The profiles of the exterior and, optionally, parallel contact surfaces of the plug head and cylindrical or curved margin of the openings complement each other so that the plug may be reliably fixed as, for instance, by snap-fitting.

If the openings are closed by an elastic plug, the cuff is provided with an opening of about the same size as the opening in the insulating jacket to allow access to the terminal screws of the screw connector for purposes of assembly. During assembly, this opening is positioned over the opening in the insulating shield. Upon completed assembly the cuff is rotated about its own axis and, at the same time, about the longitudinal axis of the sleeve, until the opening in the cuff snaps into a swelling extending at about the same circumferential line from the insulating jacket of the sleeve insulating body, thus taking up its terminal position.

For controlling the field conditions and increasing the insulating property at the interface, a refractively operating field controlling layer is dimensioned and provided at the interior surface of the cuff such that in the terminal position of the cuff it reliably covers the opening in the insulating jacket and the two margins of the inner and outer conductive layers of the sleeve insulating body in the interface.

In an alternative embodiment the cuff has no opening. During assembly of the conductors in the screw connector it is maintained in a laterally displaced parking position. After the conductors have been connected, the cuff may, by application of lubricants, be axially and longitudinally moved into its terminal position to cover the opening(s) in the insulating shield.

The field regulation above the cable end may be integrated in the grommet.

The insertion openings for the plugs and the plug stems themselves result in an electrically insulating interface which is necessary and sufficient for a proper operation of the sleeve. For this purpose the plug is provided at the outside of the plug stem with a refractively operating field controlling layer.

The insulating property of the sleeve is completed after insertion of the cable ends through the grommets and fixing the cable ends within the screw connector as well as after closure of the screw openings by field-regulated plugs. Thereafter, the jacket is connected and the outer mechanical protection is built up which forms no part of the invention.

The sleeve insulating body thus constructed may also be structured as a branch-off sleeve. In that case, it is provided with one or more cable inputs as well as, for each cable input, with one or more screw openings with plug or cuff closure. In contrast to all commercially available medium voltage branchoff connectors, this embodiments also allows for a T-shaped branch-off which, particularly in case of a short circuit, behaves more advantageously than does a so-called parallel branch-off. For inserting the cable ends into the elastic grommets push-on aids of the kind disclosed by German laid-open patent specification DE 195 10 598 A1 may be used.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a longitudinal section view of a sleeve insulating body with integrated connector;

FIG. 2 is a longitudinal sectional view of a preferred embodiment of the plug;

FIG. 3 is a view, on an enlarged scale, of the abutment edges of the inner and outer conductive layer of the sleeve insulating body extending into the openings for the shear-off screws;

FIG. 4 is a cross-sectional view of a sleeve insulating body provided with a cuff closure; and

FIG. 5 is a view in detail of the assembled cuff in the area of the opening for the shear-off screw.

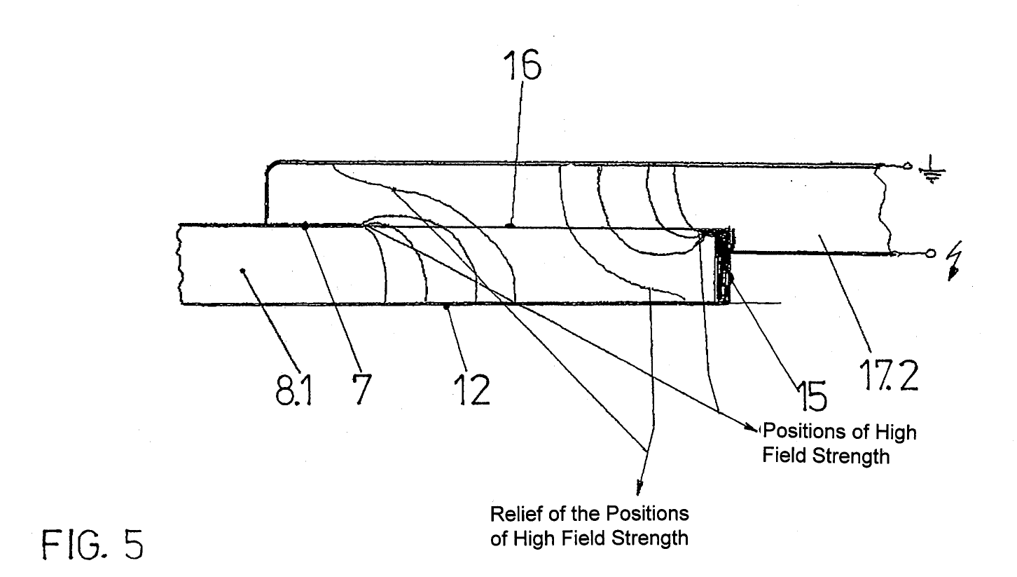

### DETAILED DESCRIPTION OF THE PREFERRED EMBODIMENTS

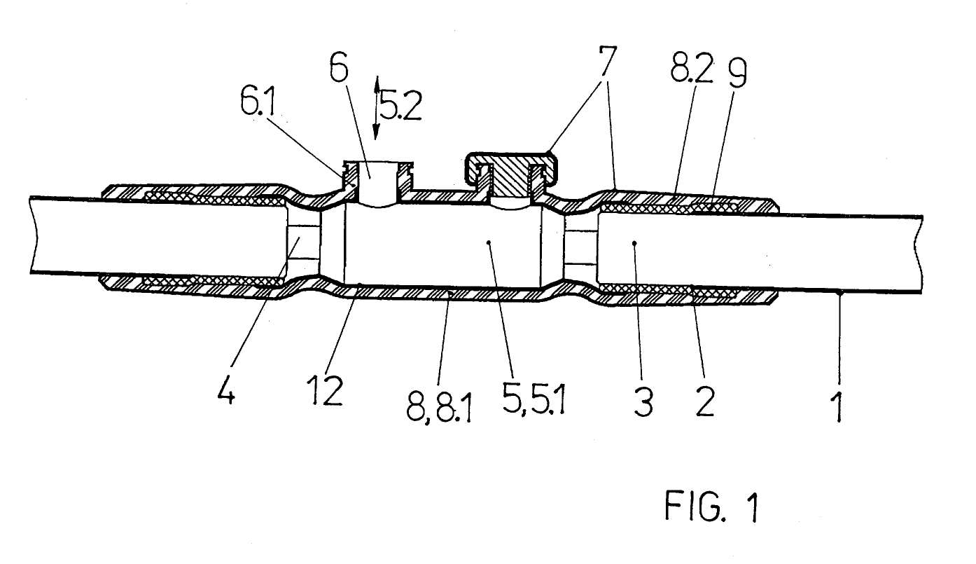

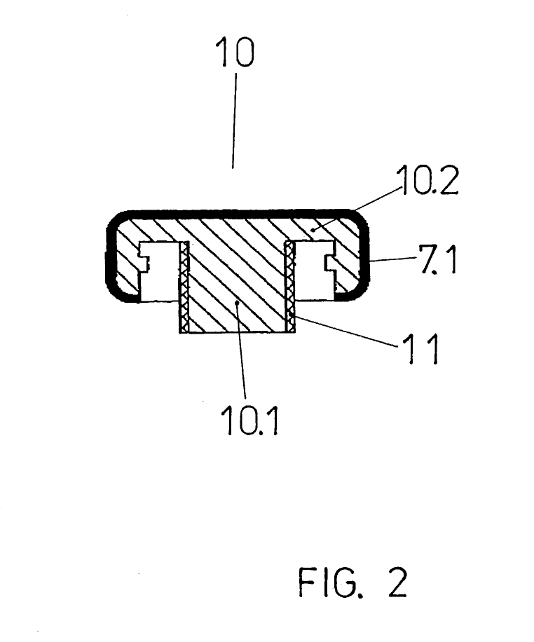

FIG. 1 depicts the basic structure of a sleeve insulating body 8 with a centrally disposed screw connector 5 enclosed by an insulating jacket 8.1. Extending in a direction away from the front surfaces of the screw connector 5, grommets 8.2 extend from the insulating jacket 8.1 for receiving cable ends in a water-impervious manner. The operation for connecting the conductors 4 of the two cable ends in the connector 5.1 is carried out by shear-off screws 5.2 through the openings 6. After completion of the assembly, the openings 6 are sealed in an water-tight manner by plugs 10 made of insulating material, see FIG. 2.

For controlling the field above the cable ends field controlling elements 9 are integrated in the grommets 8.2. The field controlling element provides the connection between the outer conductive layer of the cable 1 over the core insulation 3 and the inner conductive layer 12 of the connector 5 or sleeve insulating body 8. It extends beyond the abutment edge of the outer conductive layer 2.

The arrangement of the means for controlling the field at the plug 10 may be seen from FIG. 1 in connection with FIG. 2. A field controlling layer 11 has been applied to the plug stem 10.1. The uninterrupted formation of the outer conductive layer of the sleeve insulating body 7 also includes the plug heads 10.2. For providing a secure connection between the plug 10 and the opening 6, the opening is provided with a formed cylindrical margin 6.1 which is engaged by the plug stem 10.1 with its field controlling layer 11.

To ensure a reliable mechanical connection between the plug 10 and the sleeve insulting body 8 the plug head 10.2 is provided with a sleeve extending over the cylindrical margin 6.1 and forms a snap-fit connection with the margin 6.1 near the intersection of plug head 10.2 and cylindrical margin 6.1. The snap-connection may be augmented by a clamping ring seated at the level of the sleeve of the plug head 10.2.

The external diameter of the plug shank 10.1 including the field controlling layer 11 is at least 5% greater than the internal diameter of the opening 6 so that the interface is subject to permanent engagement pressure as is necessary for a reliable electrical insulation.

The other dimensions in the marginal area of the openings as well as in the sleeved portion of the plug are structured such that in the installed extended state no voids occur at the engaging interfaces.

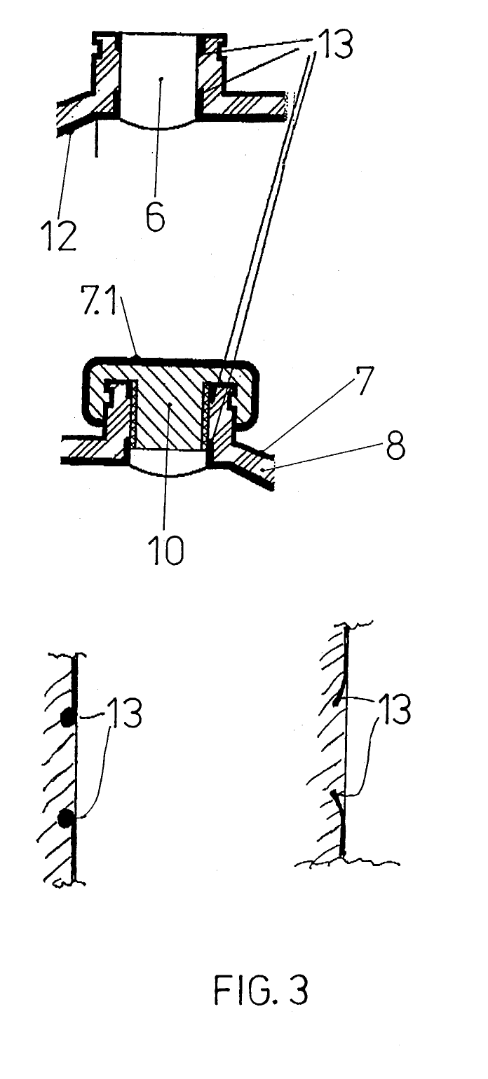

For purposes of capacitive field regulation the abutment edges 13 of the inner 12 and outer conductive layer 7, 7.1 of the sleeve insulating body 8 extending into the openings 6 may be rounded off are shaped like funnels, see FIG. 3. FIG. 3 depicts the mentioned abutment edges 13 of the two conductive layers 7, 12 in an enlarged section.

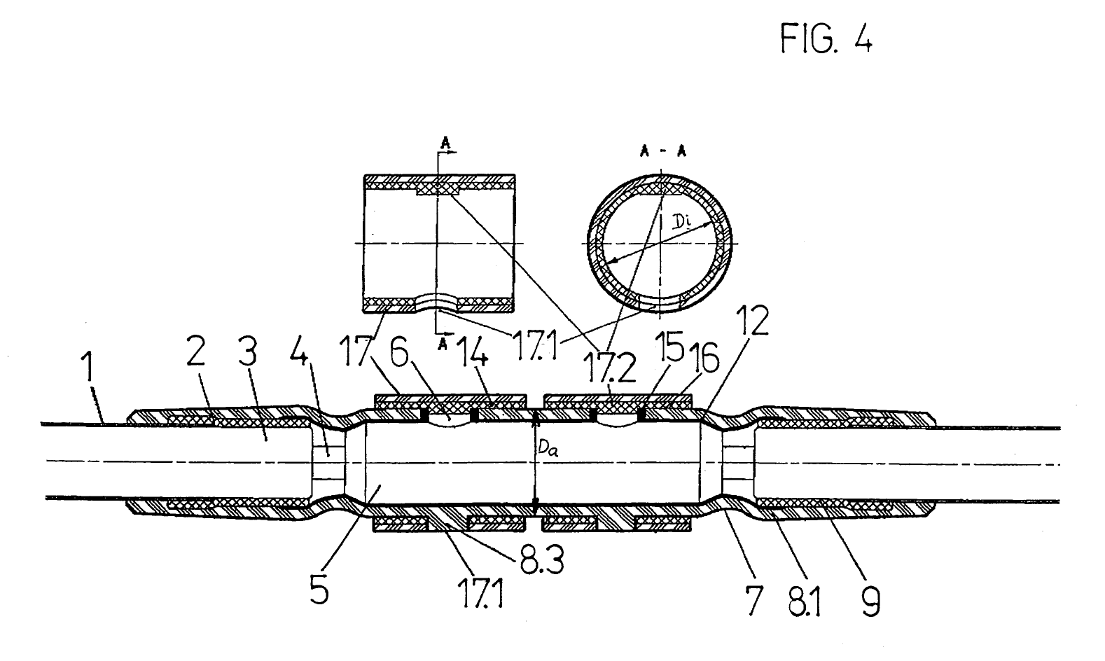

FIG. 4 depicts a sleeve insulating body 8 in which the two openings in the insulating jacket 8.1 for the shear-off screws 6 are closed by a tubular elastic cuff 17.

The height of the margin 15 of the insulating jacket in the opening 6 preferably equals the thickness of the insulating jacket 8.1 above the screw connector 5. The inner conductive layer 12 is extending outwardly and forms a circumferential conductive margin 15 of a width of, for instance, 3 mm in the plane of the insulating jacket 8.1. The outer conductive layer 7 of the sleeve insulating body 8 around the opening 6 is interrupted to the extent of providing a constant space to the margin of the inner conductive layer 12. In this manner, the insulating area of the interface 16 is formed. The length of the interface insulation, i.e. the distance between the margins of the inner and outer conductive layer 12, 7 is in the range of from about 5 mm to about 30 mm, depending upon the insulation voltage of the sleeve.

The elastic cuff 17 is arranged in the manner shown. It is formed of elastomeric materials, such as, for example, EPDM or silicon, by injection molding. Its internal diameter D1 is less than the external diameter Da of the connector above the outer conductive layer 7. The cuff is thus extended generating a permanent radial engagement pressure required for the insulating property in the interface.

For increasing the electrical insulating property in the interface 16 the cuff 17 is provided at its internal surface with a refractively functioning field controlling layer 14 which is wide enough securely to extend, in the terminal position, over both margins of the conductive layers 12, 7 in the interface 16. In the center of this range the cuff is provided with a protrusion 17.2 which in the terminal position moves into the opening 6 of the insulating jacket to contribute to securing the cuff in its terminal position. The lower side of the protrusion 17.2 and its side surfaces are conductively coated and in the assembled state are galvanically connected with the conductive layer 7 to prevent partial discharges in the void above the shear-off screw, see FIG. 2. The configuration of the inner conductive layer 12, 15 on the one hand and of the outer conductive layer 7 on the other hand result in a reduced field strength at the two margins in the interface 16. The effect may be enhanced by an appropriate configuration.

The cuff is further provided with an approximately circular opening 17.1 of the same size as the opening 6 in the insulating shield. The opening 17.1 is arranged approximately opposite the protrusion 17.2 of the cuff.

A lubricant is provided between the cuff and the surface of the cuff insulation. For assembly purposes, the cuff is rotated until the opening 17.1 and the opening 6 of cuff and cuff insulating jacket are in superposition. After tightening the screw and rapture of the screw head the cuff is rotated until its protrusion 17.2 snaps into the opening 6 in the insulating jacket (terminal position of the cuff).

The cuff is secured still further by providing a protrusion 8.3 in the sleeve insulation layer 8.1 which in the terminal position protrudes into the opening 17.1 of the cuff. This also protects the marginal portion of the opening from damage. The arrangement of the two combined insulating jacket opening 6 and the protrusion 17.2 in the cuff on the one hand and cuff opening 17.1 and insulating sleeve protrusion 8.3 on the other hand relative to each other may be such that in the assembly position the two protrusions 8.3, 17.2 are not superposed, i.e. they are displaced by an angle <180°.

At both sides of the cuffs 17 there may be provided circumferential protrusions which prevent axial shifting of the cuff. For purposes of optimizing costs the field controlling material 14 of the cuff may be provided in the area of the interface insulation 16.

In the alternative embodiment of a cuff 17 without opening 17.1 and without protrusion 17.2 is axial shifting is a functional prerequisite. During assembly of the conductor the cuff is laterally shifted into a parking position sufficiently far for the cuff to reveal the opening(s) 6.

Axial shifting of the cuff 17 into its terminal position in which it covers the opening(s) 6 is made possible by an application of a lubricant, preferably silicon oil or grease. The lubricant diffuses into the sliding cuff 17 and insulating jacket of the sleeve insulating body 8.1, and in the end results in a securely adhering connection.

The cuff may be structured as a single component for 2 to 4 screws.

The basic construction may be applied to connecting sleeves without conductive layers and field controlling layers up to 1 kV.

1. A sleeve insulating body with a screw connector for providing a cable connection for medium voltage plastic cables using a metallic sleeve-like connector with screw shafts and insertable screws vertically disposed relative to the longitudinal axis of the connector and cable and with means for reducing the electrical field strength arranged from above the screw connector to the area above the abutment edge of the outer conductive layer of the cable
characterized by the fact that a metallic screw connector (5) consisting of a connector (5.1) and connector screws (5.2) is rigidly enclosed by a sleeve insulation body (8), whereby
a) the sleeve insulating body (8) consists of an insulating jacket (8.1) which encloses the screw connector (5) and which at both front surfaces of the connector extends as elastic grommets (8.2) for receiving cable ends;
b) an the accesses to the connector screws (5.2) openings (6) are sunk into the insulating jacket (8.1) which may be closed by plugs (10) made of insulating material or by a tubular elastic cuff (12);
c) in each grommet (8.2) there is provided a field controlling element between the outer conductive layer of the cable (1) at each cable end and an inner conductive layer (12) of the sleeve insulating body (8).

2. The sleeve insulating body of claim 1,
characterized by the fact the cross section of the grommet (8.2) is variable and selected such that different shapes of conductors are enclosed in an water-impervious manner.

3. The sleeve insulating body of claim 2,
characterized by the fact that the diameter of the grommet (8.2) is selected that after assembly of the cable core of the smallest conductor cross-section of the field of application it is extended by 5%.

4. The sleeve insulating body of one of claims 1 to 3,
characterized by the fact that when closing the openings (6) by plugs (10) the walls of the plug shanks (10.1) inserted into the openings (6) are provided with a field controller and preferably at least one refractively functioning field controlling layer (11) and that the surface of the plug head (10.2) is provided with an outer conductive layer (7.1) which is galvanically connected to the outer conductive layer of the sleeve insulating body (7).

5. The sleeve insulating body of claim 4,
characterized by the fact that the openings (6) have a formed cylindrical or curved margin (6.1) the surface of which is engaged by the plug shank (10.1) with the applied field controlling layer (11) and that the cylindrical margin (6.1) is concentrically covered by the plug head (10.2).

6. The sleeve insulating body of one of claims 4 or 5,
characterized by the fact that the plug head (10.2) and cylindrical or curved margin (6.1) of the opening (6) in the insulating jacket (8.1) at their outer contact surfaces are provided with a matching profile for ensuring a reliable fixing of the plug (10) and covering of the opening (6).

7. The sleeve insulating body of one of claims 4 to 6,
characterized by the fact that for covering the cylindrical or curved margin (6.1) of the opening (6) the plug head (10.2) forms a sleeve in the direction of the cable axis and vertically of the cable axis.

8. The sleeve insulating body of one of claims 4 to 7,
characterized by the fact that the plug (10) in the area of its shank (10.1) and head (10.2) is completely structured of the field controlling material of the layer (11).

9. The sleeve insulating body of one of claims 4 to 8,
characterized by the fact that the external diameter of the plug (10) including the field controlling layer (11) is at least 5% greater than the internal diameter of the opening (6).

10. The sleeve insulating body of one of claims 4 to 9,
characterized by the fact that for controlling the field the edges (13) of the inner (12) and of the outer conductive layer (7, 7.1) of the sleeve insulating body (8) protruding into the opening (6) are rounded or of funnel-shape.

11. The sleeve insulating body of one of claims 1 to 3,
characterized by the fact that when closing the openings (6) in the insulating jacket (8.1) of the sleeve by a tubular cuff (17) the cuff mounted on the sleeve insulating body (8) has the following characteristics
a) at least one approximately circular opening (17.1) of about the same size as the opening (6) in the insulating jacket (8.1) and which during is assembly is positioned over the opening (6) to expose it and that after completed assembly is rotated by about 180° and arranged such that for fixing the cuff (17) in its terminal position it embraces a protrusion (8.3) extending opposite the opening (6) out of the insulating jacket (8.1) of the sleeve,
b) a refractively functioning field controlling layer (14) is disposed at the internal surface of the cuff (17) for increasing the electrical insulation properties in the interface (16) and which is sufficiently wide that in the terminal position it securely covers the opening (6) and both margins of the conductive layers (7, 12) in the interface (16).

12. The sleeve insulating body of claim 11,
characterized by the fact that the insulating jacket (8.1) is provided with a margin (15) the height of which in the opening (6) preferably corresponds to the thickness of the insulating jacket (8.1) over the screw connector (5), whereby the inner conductive layer (12) of the sleeve insulating body is extending outwardly to form the margin (15) circumscribing the opening (6).

13. The sleeve insulating body of claim 11 or 12,
characterized by the fact that the outer conductive layer (7) of the sleeve insulating body which circumscribes the opening (6) is sufficiently interrupted to form a constant space between the margin (15) of the inner conductive layer (12) which forms the insulating area of the interface (16).

14. The sleeve insulating body of claim 13,
characterized by the fact that the space of the interface insulation (16), i.e. the distance between the margins of the inner and outer conductive layers (12, 7) of the sleeve insulating body is between 5 mm and 30 mm, depending on the insulation voltage of the sleeve.

15. The sleeve insulating body of one of claims 11 to 14,
characterized by the fact that at the internal surface of the field controlling layer (14) the cuff (17) is provided with a protrusion (17.2) disposed such that in the terminal position it positively protrudes into the opening (6).

16. The sleeve insulating body of claims 15,
characterized by the fact that the protrusion (17.2) in the field controlling layer (14) is conductively coated or consists of a conductive elastomeric material.

17. The sleeve insulating body of one of claims 11 to 16,
characterized by the fact that in its initial state the tubular elastic cuff (17) is dimensioned that its internal diameter D1 is smaller than the external diameter Da of connector (5) and insulating jacket (8.1) over the outer conductive layer (7).

18. The sleeve insulating body of one of claims 11 to 17,
characterized by the fact that the two pairs insulating jacket—opening (6) and cuff protrusion (17.2) on the one hand and cuff—opening (17.1) and insulating jacket protrusion (0.3) on the other hand are arranged above the radial circumference of the sleeve such that in the terminal position the two protrusions are not in superposition.

19. The sleeve insulating body of one of claims 11 to 18,
characterized by the fact that circumferential protrusions are arranged at both ends the cuff (17).

20. The sleeve insulating body of one of claims 11 to 19,
characterized by the fact that the field controlling layer (14) in the cuff (17) is disposed only in the are of the insulating space of the interface (16).

21. The sleeve insulating body of one of claims 11 to 20,
characterized by the fact that a geometric field regulation is utilized in the interface (16).

22. The sleeve insulating body of one of claims 11 to 20,
characterized by the fact that no special field regulation is utilized in the interface (16) and that the configuration of the outer and of the inner conductive layer (7, 12) abutting the margin provides the geometric field regulation.

23. The sleeve insulating body of one of claims 4 to 7,
characterized by the fact that the cuff (17) is formed as a single piece for two to four shear-off screws.

24. The sleeve insulating body of one of claims 11 to 23,
characterized by the fact that the basic without conductive layers and field controlling layers may also be utilized in connection sleeves up to 1 kV.

25. The sleeve insulating body of one of claims 1 to 24,
characterized by the fact that the field controlling element (9) over the cable end is integrated in the grommet (8.2).

26. The sleeve insulating body of one of claims 1 to 25,
characterized by the fact that it is structured as a branch-off sleeve whereby one or more cable inputs are provided and that for each cable input one or more further screw openings (6) are provided with plugs (10).
